(19) United States
(12) Patent Application Publication
(10) Pub. No.: US 2025/0157091 A1
(43) Pub. Date: May 15, 2025

(54) METHOD AND DEVICE FOR POST-TRAINING A MACHINE LEARNING SYSTEM

(71) Applicant: Robert Bosch GmbH, Stuttgart (DE)

(72) Inventor: Jan Hendrik Metzen, Boeblingen (DE)

(21) Appl. No.: 18/934,425

(22) Filed: Nov. 1, 2024

(30) Foreign Application Priority Data
Nov. 10, 2023 (DE) 10 2023 211 185.3

(51) Int. Cl. G06T 11/00; G06T 7/00; G06V 10/74; G06V 10/764

(52) U.S. Cl. CPC G06T 11/00; G06T 7/0002; G06V 10/761; G06V 10/764; G06T 2207/30168

(57) ABSTRACT

A computer-implemented method for post-training a machine learning system. The machine learning system is configured to generate digital images under the specification of a spatial image structure. The method includes: receiving training data, which each contain specifications of a spatial image structure, by means of the machine learning system; adding further parameters to the machine learning system; generating an image for each training datum by means of the machine learning system; ascertaining the spatial image structure of an image generated by the machine learning system, by means of a second machine learning system; and adjusting the further parameters by using a loss function, which measures a similarity between the ascertained spatial image structure of a generated image and the spatial image structure specified by the associated training datum.

### CROSS REFERENCE

The present application claims the benefit under 35 U.S.C. § 119 of German Patent Application No. DE 10 2023 211 185.3 filed on Nov. 10, 2023, which is expressly incorporated herein by reference in its entirety.

### FIELD

The present invention relates to a method for post-training a machine learning system, wherein the machine learning system is configured to generate digital images under the specification of a spatial image structure. The present invention furthermore relates to a device configured to perform the aforementioned method, to a computer program implementing the aforementioned method, and to a machine-readable data carrier with such a computer program.

### BACKGROUND INFORMATION

When training machine learning systems in the field of computer vision, training data sets that comprise real images may be expanded or supplemented by synthetically generated images. Alternatively, training data sets may also exclusively comprise synthetically generated images. In systems particular, machine learning that assume safety-critical tasks in the inference, as, for example, in the use of a corresponding machine learning system in at least partially autonomous driving, in automatic optical inspection, in monitoring or in interior monitoring of vehicles, require a sufficient number of training data during training, which training data in particular must also represent rare but possibly particularly safety-critical situations/constellations. If corresponding real image data are not available, it may therefore be necessary to synthetically generate corresponding images by means of a generative machine learning system.

Generative machine learning systems for image generation are provided, for example, by diffusion models (DMs). Diffusion models add random noise to input image data in a Markov chain of diffusion steps at each step and then learn a reversal of the diffusion process during training so that, in the inference from the input of a noisy image and a text prompt, “desired” image data can be obtained according to the text prompt.

In arXiv:2302.05543v1 [cs. CV], a neural network architecture, ControlNet, is described, which is designed to control a diffusion model by adding additional conditions, i.e., in other words, which is designed to be able to more specifically control the construction of the images generated by the diffusion model, with regard to the image structure or the arrangement and/or position of the objects depicted in the image. A ControlNet can thus be used to specifically control or influence certain properties of an image generated by a diffusion model. A ControlNet as described in arXiv:2302.05543v1 [cs. CV] is based on a stable diffusion model, cf. arXiv:2112.10752 [cs. CV].

In doi.org/10.1016/j.neunet.2009.12.004, a method for adjusting the parameters of a machine learning system based on evolutionary algorithms is described. In contrast to the backpropagation method for ascertaining the minimum (or maximum) of a loss function under consideration, the method first involves initializing a current set of parameter values of a machine learning system, as well as drawing N further sets of parameter values from a distribution whose center is given by the currently initialized set of parameter values. For the drawn N sets of parameter values, the value of a loss function selected with regard to a target task is in each case calculated and, based thereon, a gradient of the loss function is estimated. Using this estimated gradient, the set of parameter values is updated. The steps are iterated accordingly until a minimum or maximum of the loss function under consideration has been approximated with a desired accuracy.

### SUMMARY

In a first aspect, the present invention relates to a computer-implemented method for post-training a machine learning system. According to an example embodiment of the present invention, the machine learning system is configured to generate digital images under the specification of a spatial image structure. An image generated by the machine learning system can, for example, show an environmental situation, in particular a driving environment of an at least partially autonomous robot, a workpiece or a detail of a workpiece in the automated optical inspection of workpieces, or at least one person in an area to be monitored by a surveillance camera, e.g., inside or outside a building. A spatial image structure may, for example, be determined or specified by defining an arrangement, a position, a size of objects in the image, a relative size of multiple objects to one another, information about the foreground and background, a position and/or an orientation of individual objects in the image. The spatial image structure may, for example, be specified by assigning a content to be represented in the image to be generated to image areas, i.e., for example, a contiguous set of pixels, in an image mask that has the same size in terms of the number and arrangement of image pixels as an image to be generated by the machine learning system. An image mask may, for example, be a semantic segmentation mask, through which different image areas can be separated from one another with regard to their semantic content and in which the semantic content of the image areas can in each case be specified in the form of a label. A separation of image areas with regard to their semantic content may, for example, be realized in that the pixel values in image areas with the same semantic content can each assume the same value and that image areas with different content in the image mask can differ from one another with regard to the values assigned to the pixels. An image mask may alternatively be an image mask with a human keypoint pose. In a prototype of the image to be generated, with the same dimensions as the image to be generated itself, the positions and posture of human limbs, e.g., the extremities, head, eyes, chin, neck, hands and/or torso, in a keypoint pose can be represented in the form of (part of a) “stick figure” by interconnected image points. Preferably, the machine learning system is a generative probabilistic text-to-image diffusion model. Blocks of the aforementioned diffusion model with their parameters are duplicated into a locked copy and a trainable copy. The method comprises at least the steps described below. In one method step, training data are received by the machine learning system. The training data each comprise specifications for a spatial image structure. Preferably, the spatial image structure is given by an image mask, which is a semantic segmentation mask or an image mask with a human keypoint pose. In a further method step, further parameters are added to a trainable copy of at least one duplicated block of the diffusion model. This can be achieved by inserting at least one additional layer parameterized with the further parameters, into the trainable copy of a duplicated block. Alternatively or additionally, the further parameters can be added by decomposing at least one weight matrix to be adjusted in the post-training, in a trainable copy of a duplicated block, into a sum of a pre-trained weight matrix and a further summand added in the post-training. The further summand is given by the matrix product of two further matrices. The two further matrices are parameterized with the further parameters, and the parameters of the pre-trained weight matrix have been adjusted in the pre-training of the diffusion model and are retained in the post-training. The ranks of the two further matrices are each lower than the rank of the pre-trained weight matrix. In a further method step, the machine learning system generates an image for each received training datum. In a subsequent step, the spatial image structure of an image generated by the machine learning system is ascertained in that the corresponding generated image is supplied to a second machine learning system, which is configured to ascertain a spatial image structure of a digital image, and this second machine learning system ascertains the spatial image structure of the corresponding image. In a further step, the further parameters are adjusted using a loss function, wherein the loss function measures a similarity between the ascertained spatial image structure of an image generated by the machine learning system and the spatial image structure specified by the training datum associated with the generated image.

An advantageous aspect of the aforementioned method described below is that not all parameters in the trainable copies need to be adjusted during post-training. In particular, this can lead to a reduction in the required training time and/or the required training data and thus allow a faster and/or more cost-effective adjustment of the machine learning system.

According to a preferred embodiment of the present invention, the further parameters are adjusted by means of a distribution-based evolutionary algorithm.

Advantageously, this allows learning systems or loss functions to be used that are not continuously differentiable. This is useful, for example, if metrics, such as mean intersection over union (IoU), are to be optimized directly. Another advantage over the use of gradient-based optimization is that, due to the iterative diffusion process in a diffusion model, the activations of all intermediate steps must be kept in memory during backpropagation. The latter can quickly lead to an out-of-memory problem and is avoided by using an evolutionary algorithm as proposed here. Furthermore, an advantage of using gradient-free optimization over gradient-based optimization is that “vanishing gradient” problems could occur in the backpropagation by an “unrolled” diffusion model, similarly as in recurrent networks, for example. The latter problem would make gradient-based optimization more difficult and is avoided by using a gradient-free method.

In particular, according to an example embodiment of the present invention, the distribution-based evolutionary algorithm may be a derivative-free policy gradient estimation algorithm.

According to a preferred embodiment of the present invention, the loss function is given by a non-differentiable metric. In the case of the specification of a semantic image structure through a semantic segmentation mask, the non-differentiable metric as a specification for the spatial image structure may, for example, be given by the mean IoU metric. According to a further, preferred embodiment of the present invention, the loss function used may alternatively be the pixel-wise cross entropy or the mean squared error per keypoint, which, in contrast to the mean IoU metric, are each differentiable. The pixel-wise cross entropy can also provide a comparatively good uncertainty calibration.

According to a preferred embodiment of the present invention, two adapter layers are inserted at least in a duplicated copy of a transformer block and the parameters added by inserting the adapter layers are adjusted in the post-training by using the loss function.

Advantageously, this reduces the number of the parameters to be adjusted during post-training. This is in particular advantageous with regard to the duration of the post-training: Firstly, the method described here may be slower than post-training by means of backpropagation. However, this effect of a longer training duration can in some circumstances be partially compensated by a reduced number of parameters to be adjusted. (Post-) training by means of an evolution-based estimation algorithm may be slower than (post-) training by means of backpropagation since the loss for multiple sampled parameter sets must be ascertained in each training epoch in order to estimate the gradient, instead of calculating the gradient on the basis of “only” one parameter set by means of backpropagation.

According to a preferred embodiment of the present invention, at least one trainable copy of a transformer block is in each case preceded by a prefix of length K. The key vector and the value vector can in this case each be modified in a self-attention layer of a transformer block by the prefix of the associated transformer block. Furthermore, an additional gating mechanism with a scalar parameter can be introduced, wherein the parameters associated with the prefix and the scalar parameter of the gating mechanism are added parameters that are adjusted in the post-training of the machine learning system.

In the example embodiment of the present invention described above, the number of the parameters to be adjusted in the post-training is also advantageously reduced so that the advantages, mentioned above in connection with a reduced number of parameters to be adjusted, with regard to the duration, and thus possibly also the costs, of the post-training can result.

According to a preferred embodiment of the present invention, further added parameters adjusted in the post-training can be obtained by representing a weight matrix Wᵢ to be adjusted in the post-training, in a layer of at least one trainable copy of a duplicated block as a sum Wᵢ=W_{i,0}+W_{i,A}·W_{i,B} of a pre-trained weight matrix W_{i,0} and a product of two further matrices, each with a lower rank than the rank of the weight matrix W_{i,0}, wherein the elements of the two further matrices are each added parameters to be adjusted in the post-training. The first term of the sum Wᵢ=W_{i,0}+W_{i,A}·W_{i,B} comprises an A×B weight matrix W_{i,0}, which corresponds to the corresponding layer and whose entries have been adjusted in a pre-training of the machine learning system and are not changed in the post-training. The second term is given by a matrix product of the matrices W_{i,A} and W_{i,B}. Here, W_{i,A} denotes an A×r and W_{i,B} denotes an r×B matrix, whose entries are each added parameters that are adjusted during post-training. r denotes a freely selectable hyperparameter determining the rank of the matrices W_{i,A}, W_{i,B}. The hyperparameter r may take a value smaller than the value of the rank of the matrix W_{i,0}. Preferably, r may, for example, take a value of r≤16. For example, r may take a value of r=4. For example, the added parameters, i.e., the entries, of a matrix W_{i,A} may be initialized randomly (e.g., in a Gaussian-distributed manner). The parameters, i.e., matrix entries, of a matrix W_{i,B} may be set to zero initially, i.e., at the beginning of the post-training.

In this embodiment of the present invention described above, the number of the parameters to be adjusted in the post-training is also advantageously reduced so that the advantages, mentioned above in connection with a reduced number of parameters to be adjusted, with regard to the duration, and thus possibly also the costs, of the post-training can again result.

Preferably, according to an example embodiment of the present invention, the specifications of a spatial image structure can in each case be given by a semantically segmented image, i.e., a semantic segmentation mask, or by an image or an image mask with at least one human keypoint pose.

According to a preferred embodiment of the present invention, a training datum furthermore comprises text composed of multiple words, wherein the text describes the quality and/or the content of the image to be generated by the machine learning system. Through text also contained in the training datum, in addition to a specification of a spatial image structure, a further possibility of controlling the content of the image to be generated is provided. The text may, for example, be used to define the resolution or the style of the image and/or to define whether the image should be a night-time image/darkened image/image blurred, or fuzzy, or “smudged” due to fog or other weather conditions. This provides a further possibility of generating a variety of images, e.g., of safety-critical situations in autonomous driving, automated optical inspection, or interior monitoring or object monitoring, which do represent a specified spatial structure but, for example, a different time of day, a different season, different weather conditions, etc. and/or a different type of objects in the image. Another type, for example in a background area in a semantic segmentation mask in the case of a driving environment, may be given by bushes, trees, agricultural areas, an urban environment, etc. In the case of a keypoint pose, text may furthermore be used to specify, among other things, what shape, what clothing and/or what objects the person depicted should hold in their hands, for example. For example, the text may specify that persons with firearms or other dangerous objects should be depicted in an image to be generated. This makes it possible for the machine learning system to generate images that contain safety-critical situations and can be used in the training of a machine learning system, wherein the latter learning system is to be used in the context of autonomous driving, automated optical inspection, or object monitoring.

According to a preferred embodiment of the present invention, the diffusion model has a U-Net structure with multiple encoder blocks, multiple decoder blocks and a middle block. In this case, one of the aforementioned blocks may in each case comprise multiple layers of a machine learning system, which together form a functional unit within the structure of the machine learning system. For example, a block may be a ResNet block, transformer block, multi-head attention block, conv-bn-relu block, etc.

According to a preferred embodiment of the present invention, the encoder blocks and the middle block of the diffusion model with the U-Net structure are each duplicated into a trainable copy and a locked copy. The trainable copy may in each case be connected to the associated locked copy of a block by a convolutional layer. In particular, the convolutional layer may be a zero-convolutional layer. A zero-convolutional layer may be a convolutional layer in which both weights and biases are in each case initialized to zero. The function of a zero-convolutional layer may be either to feed the specification of the spatial image structure into the representation space initially, or to feed representations ascertained by the trainable encoder blocks or the trainable middle block, into the decoder blocks of the machine learning system by addition at later points in the architecture of the machine learning system.

According to a preferred embodiment of the present invention, the digital images generated by means of the post-trained machine learning system are training data for an image classifier for image classification. The image classification by the aforementioned image classifier may in particular be based on low-level features. Low-level features may, for example, be edges or pixel attributes for images.

In particular, the images generated by means of the post-trained machine learning system may show a driving environment of an at least partially autonomous robot, or at least a detail of a workpiece to be checked for defects and/or functionality, or an environmental situation from the perspective of a surveillance camera.

According to a further aspect, the present invention relates to a device, e.g., a computer, which comprises means for performing a method of the present invention described above.

Furthermore, the present invention also relates to a computer program comprising machine-readable instructions which, when executed on one or more computers, cause the computer(s) to perform one of the methods according to the present invention described above and below. The present invention also comprises a machine-readable data carrier on which the above computer program is stored, as well as a computer equipped with the aforementioned computer program and/or the aforementioned machine-readable data carrier.

Embodiments of the present invention will be explained in detail below with reference to the figures.

### BRIEF DESCRIPTION OF THE DRAWINGS

FIG. 1 schematically shows a training system, according to an example embodiment of the present invention.

FIG. 2 schematically shows an information flow overview of an example method of the present invention described herein.

### DETAILED DESCRIPTION OF EXAMPLE EMBODIMENTS

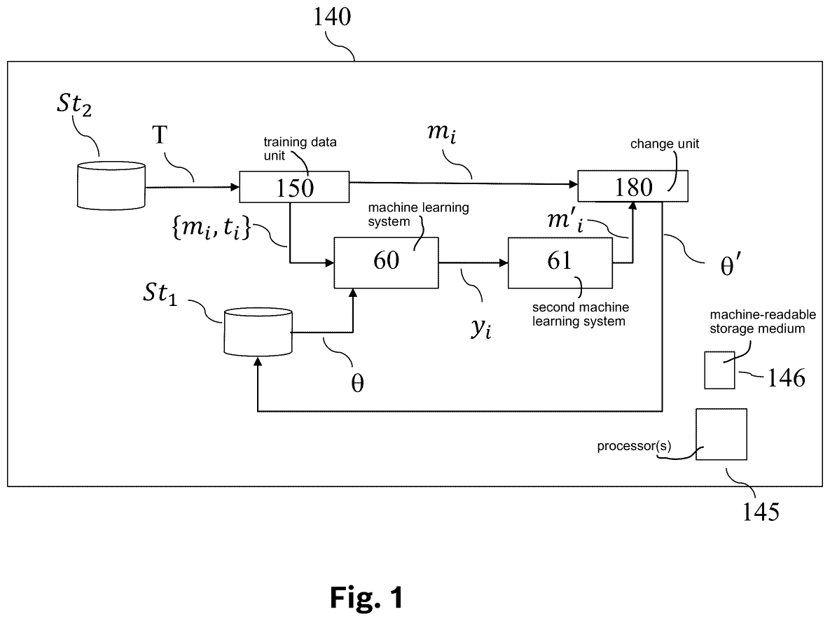

FIG. 1 shows an exemplary embodiment of a training system 140 for post-training a machine learning system 60 by means of a training data set T, wherein the machine learning system is configured to generate digital images under the specification of a spatial image structure. The training data set T comprises a plurality of input signals {{mᵢ, tᵢ}, which are used to train the machine learning system 60. The training data T may each comprise specifications mᵢ for a spatial image structure of a digital image to be generated in each case. The specifications for the spatial image structure may, for example, be given in the form of a semantic segmentation mask mᵢ or in the form of a keypoint pose mᵢ. In general, a training datum can be used in addition to a specification for the spatial image structure, mᵢ, text tᵢ, which is composed of multiple words and describes the quality and/or the content of the image to be generated by the machine learning system.

The machine learning system 60 may be a generative probabilistic text-to-image diffusion model, wherein blocks of the diffusion model with their parameters are duplicated into a locked copy and a trainable copy.

Further parameters θ to be adjusted in the post-training are added to the parameters of the machine learning system 60 that have already been adjusted in a pre-training. This can be done by inserting at least one additional layer into a trainable copy of a duplicated block of the learning system 60. Alternatively or additionally, further parameters can be obtained by representing a weight matrix to be adjusted in the post-training, in a layer of a trainable copy of a duplicated block of the machine learning system as the sum of a pre-trained weight matrix and a matrix product of two further matrices, each with a lower rank, and by the elements of the two further matrices in this case specifying added further parameters θ.

For the training, a training data unit 150 accesses a computer-implemented database St₂, wherein the database St₂ provides the training data set T. From the training data set T, the training data unit 150 preferably randomly ascertains at least one input signal {mᵢ,tᵢ}, which preferably comprises at least one specification for a spatial image structure mᵢ and text tᵢ, which comprises the content and/or the quality of the image to be generated. The training data unit 150 transmits the input signal {mᵢ, tᵢ} to the machine learning system 60. The machine learning system 60 ascertains an output signal yᵢ on the basis of the input signal, i.e., the learning system generates a digital image yᵢ as an output signal. The generated image yᵢ is transmitted from the machine learning system 60 to a second machine learning system 61. The second machine learning system is configured to use the input of a digital image to ascertain, as output, a spatial image structure of the digital image received as input. That is to say, on the basis of a digital input image, the second machine learning system 61 can ascertain a semantic segmentation of the image or the keypoint pose of one or more persons depicted in the image. The second machine learning system 61 then ascertains the spatial image structure m′ᵢ of an image yᵢ. generated by the machine learning system 60. The spatial image structure mᵢ specified by the associated training datum and the spatial image structure m′ᵢ, ascertained by the second machine learning system 61, of the image yᵢ generated for the associated training datum are transmitted to a change unit 180.

Based on the spatial image structure mᵢ specified by the training datum and the ascertained spatial image structure m′ᵢ, the change unit 180 then determines new parameters θ′ for the machine learning system 60. For this purpose, the change unit 180 compares, for example, the specified semantic segmentation mask mᵢ or the specified keypoint pose(s) mᵢ with the ascertained segmentation mask m′ᵢ or the ascertained keypoint pose(s) m′ᵢ by means of a loss function, which measures a similarity between the ascertained spatial image structure of an image generated by the machine learning system and the spatial image structure specified by the training datum associated with the generated image. The loss function ascertains a first loss value, which characterizes how far the ascertained spatial image structure deviates from the specified spatial image structure, or how great the similarity between the spatial image structures is. In the exemplary embodiment, a non-differentiable metric, such as mean intersection over union (IoU), may preferably be selected as the loss function. In alternative exemplary embodiments, other loss functions are also possible.

The change unit 180 ascertains the new parameters θ′ on the basis of the first loss value. In the exemplary embodiment, this is done by means of a distribution-based evolutionary algorithm. Preferably, this may be a derivative-free policy gradient estimation algorithm.

The ascertained new parameters θ′ are stored in a model parameter memory St₁. Preferably, the ascertained new parameters θ′ are provided as parameters φ to the machine learning system 60.

In further, preferred exemplary embodiments, the described training is repeated iteratively for a predefined number of iteration steps or repeated iteratively until the first loss value falls below a predefined threshold value. Alternatively or additionally, it is also possible that the training is terminated when an average first loss value for a test or validation data set falls below a predefined threshold value. In at least one of the iterations, the new parameters θ′ determined in a previous iteration are used as parameters θ of the machine learning system 60.

Furthermore, the training 140 may comprise at least one processor 145 and at least one machine-readable storage medium 146 containing commands that, when executed by the processor 145, cause the training system 140 to perform a training method according to one of the aspects of the present invention.

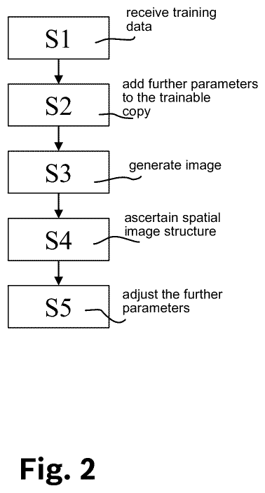

FIG. 2 shows a schematic information flow overview of an embodiment of a computer-implemented method, described here, for post-training a machine learning system. The machine learning system is preferably configured to generate digital images under the specification of a spatial image structure. Preferably, the machine learning system is a generative probabilistic text-to-image diffusion model, wherein blocks of the diffusion model with their parameters are duplicated into a locked copy and a trainable copy. In a first method step S1, the machine learning system receives training data, each of which comprises specifications for a spatial image structure. In a further method step S2, further parameters are added to the trainable copy of at least one duplicated block of the diffusion model. The further parameters can be added to the trainable copy of a duplicated block by inserting at least one additional layer parameterized with the further parameters. Alternatively, the further parameters can be added by decomposing at least one weight matrix to be adjusted in the post-training, in a trainable copy of a duplicated block, into a sum of a pre-trained weight matrix and a further summand added in the post-training. The further summand is given by the matrix product of two further matrices, wherein the two further matrices are parameterized with the further parameters. The parameters of the pre-trained weight matrix have preferably been adjusted in a pre-training and are retained in the post-training. The ranks of the two further matrices are preferably each lower than the rank of the pre-trained weight matrix. In method step S3, an image for a training datum is in each case generated by the machine learning system. In step S4, the spatial image structure of an image generated by the machine learning system is ascertained by a second machine learning system for ascertaining a spatial image structure of a digital image. Thereafter, the further parameters are adjusted in step S5, namely, by using a loss function, which measures a similarity between the ascertained spatial image structure of an image generated by the machine learning system and the spatial image structure specified by the training datum associated with the generated image. A distribution-based evolutionary algorithm is preferably used here.

The term “computer” includes any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

What is claimed is:

1. A computer-implemented method for post-training a machine learning system, wherein the machine learning system is configured to generate digital images under a specification of a spatial image structure, wherein the machine learning system is a generative probabilistic text-to-image diffusion model, wherein blocks of the diffusion model with parameters of the blocks are duplicated into a locked copy and a trainable copy, the method comprising the following steps:
receiving training data, which each contain specifications of a spatial image structure, by the machine learning system;
adding further parameters to the trainable copy of at least one duplicated block of the diffusion model;
wherein:
the further parameters are added to the trainable copy of a duplicated block by inserting at least one additional layer parameterized with the further parameters, and/or
the further parameters are added by decomposing at least one weight matrix to be adjusted in the post-training, in a trainable copy of a duplicated block, into a sum of a pre-trained weight matrix and a further summand added in the post-training, wherein the further summand is given by the matrix product of two further matrices, wherein the two further matrices are parameterized with the further parameters, wherein the parameters of the pre-trained weight matrix have been adjusted in a pre-training and are retained in the post-training, wherein ranks of the two further matrices are each lower than a rank of the pre-trained weight matrix;
generating an image for each training datum by the machine learning system;
ascertaining a spatial image structure of an image generated by the machine learning system, by a second machine learning system for ascertaining a spatial image structure of a digital image; and
adjusting the further parameters by using a loss function which measures a similarity between the ascertained spatial image structure of the image generated by the machine learning system and the spatial image structure specified by the training datum associated with the generated image.

2. The method according to claim 1, wherein the further parameters are adjusted using a distribution-based evolutionary algorithm.

3. The method according to claim 1, wherein the loss function is given by a non-differentiable metric.

4. The method according to claim 1, wherein two adapter layers are inserted at least in a duplicated copy of a transformer block, wherein the parameters added by inserting the adapter layers are adjusted in the post-training by using the loss function.

5. The method according to claim 1, wherein at least one trainable copy of a transformer block is in each case preceded by a prefix of length K, wherein a key vector and a value vector in a self-attention layer of a transformer block can in each case be modified by the prefix of the associated transformer block, wherein an additional gating mechanism with a scalar parameter is introduced, wherein the parameters associated with the prefix and the scalar parameter of the gating mechanism are added parameters, which are adjusted in the post-training.

6. The method according to claim 1, wherein the further parameters are added by decomposing a weight matrix Wᵢ to be adjusted in the post-training, in a layer of a trainable copy of a duplicated block, into a sum Wᵢ=W_{i,0}+W_{i,A}·W_{i,B} of a pre-trained weight matrix W_{i,0} and a product of two further matrices, each with a lower rank than a rank of the weight matrix W_{i,0}, wherein elements of the two further matrices are each added parameters to be adjusted in the post-training,
wherein:
W_{i,0} denotes an A×B weight matrix of the machine learning system, which weight matrix corresponds to the layer and entries of which weight matrix have been adjusted in the pre-training and are not changed,
W_{i,A} denotes an A×r matrix and W_{i,B} denotes an r×B matrix, whose entries are added parameters which are adjusted with regard to the target task in the post-training,
r is a freely selectable hyperparameter determining a rank of the matrices W_{i,A}, W_{i,B}.

7. The method according to claim 1, wherein each training datum further includes text, which includes multiple words and describes a quality and/or a content of the image to be generated by the machine learning system.

8. The method according to claim 1, wherein the diffusion model has a U-Net structure with multiple encoder blocks, multiple decoder blocks, and a middle block.

9. The method according to claim 7, wherein the encoder blocks and the middle block of the diffusion model are each duplicated into a trainable copy and a locked copy, and wherein the trainable copy is in each case connected to the locked copy of a block by a convolutional layer.

10. The method according to claim 1, wherein digital images generated by the post-training machine learning system are training data for an image classifier for image classification, based on low-level features.

11. The method according to claim 10, wherein the images generated by the post-trained machine learning system show: (i) a driving environment of an at least partially autonomous robot, or (ii) at least a detail of a workpiece to be checked for defects and/or functionality, or (iii) an environmental situation from a perspective of a surveillance camera.

12. A device configured to post-train a machine learning system, wherein the machine learning system is configured to generate digital images under a specification of a spatial image structure, wherein the machine learning system is a generative probabilistic text-to-image diffusion model, wherein blocks of the diffusion model with parameters of the blocks are duplicated into a locked copy and a trainable copy, the device configured to:
receive training data, which each contain specifications of a spatial image structure, by the machine learning system;
add further parameters to the trainable copy of at least one duplicated block of the diffusion model;
wherein:
the further parameters are added to the trainable copy of a duplicated block by inserting at least one additional layer parameterized with the further parameters, and/or
the further parameters are added by decomposing at least one weight matrix to be adjusted in the post-training, in a trainable copy of a duplicated block, into a sum of a pre-trained weight matrix and a further summand added in the post-training, wherein the further summand is given by the matrix product of two further matrices, wherein the two further matrices are parameterized with the further parameters, wherein the parameters of the pre-trained weight matrix have been adjusted in a pre-training and are retained in the post-training, wherein ranks of the two further matrices are each lower than a rank of the pre-trained weight matrix;
generate an image for each training datum by the machine learning system;
ascertain a spatial image structure of an image generated by the machine learning system, by a second machine learning system for ascertaining a spatial image structure of a digital image; and
adjust the further parameters by using a loss function which measures a similarity between the ascertained spatial image structure of the image generated by the machine learning system and the spatial image structure specified by the training datum associated with the generated image.

13. A non-transitory machine-readable storage medium on which is stored a computer program for post-training a machine learning system, wherein the machine learning system is configured to generate digital images under a specification of a spatial image structure, wherein the machine learning system is a generative probabilistic text-to-image diffusion model, wherein blocks of the diffusion model with parameters of the blocks are duplicated into a locked copy and a trainable copy, the computer program, when executed by a computer, causing the computer to perform the following steps:
receiving training data, which each contain specifications of a spatial image structure, by the machine learning system;
adding further parameters to the trainable copy of at least one duplicated block of the diffusion model;
wherein:
the further parameters are added to the trainable copy of a duplicated block by inserting at least one additional layer parameterized with the further parameters, and/or
the further parameters are added by decomposing at least one weight matrix to be adjusted in the post-training, in a trainable copy of a duplicated block, into a sum of a pre-trained weight matrix and a further summand added in the post-training, wherein the further summand is given by the matrix product of two further matrices, wherein the two further matrices are parameterized with the further parameters, wherein the parameters of the pre-trained weight matrix have been adjusted in a pre-training and are retained in the post-training, wherein ranks of the two further matrices are each lower than a rank of the pre-trained weight matrix;
generating an image for each training datum by the machine learning system;
ascertaining a spatial image structure of an image generated by the machine learning system, by a second machine learning system for ascertaining a spatial image structure of a digital image; and
adjusting the further parameters by using a loss function which measures a similarity between the ascertained spatial image structure of the image generated by the machine learning system and the spatial image structure specified by the training datum associated with the generated image.
